(19) United States
(12) Patent Application Publication
(10) Pub. No.: US 2007/0051004 A1
(43) Pub. Date: Mar. 8, 2007

(54) MULTI-POINT MEASURING SYSTEM AND METHOD

(76) Inventor: Chia-Liang Liu, Shenzhen (CN)

Correspondence Address: NORTH AMERICA INTELLECTUAL PROPERTY CORPORATION, P.O. BOX 506, MERRIFIELD, VA, 22116, US

(21) Appl. No.: 11/308,318

(22) Filed: Mar. 16, 2006

(30) Foreign Application Priority Data
Sep. 2, 2005 (CN) 200510037018.X

(51) Int. Cl. G01B 5/20

(52) U.S. Cl. 33/552

(57) ABSTRACT

A multi-point measuring method includes steps of: sending controlling commands to at least two measuring tools to control the at least two measuring tools to measuring two different points of a component; receiving at least two measuring values from the at least two measuring tools; and showing the at least two measuring values on an user interface.

### FIELD OF THE INVENTION

This invention relates to measuring systems and methods and, more particularly, to a multi-point measuring system and a multi-point measuring method.

### DESCRIPTION OF RELATED ART

In order to provide acceptable products to consumers, some tests should be done before the products being put to market. Various measuring tools are employed for the tests, including rulers and probes for measuring sizes or surface characteristics of products. In order to perform multi-point measures multiple measuring tools are required to work simultaneously. Referring to FIG. 5, a measuring apparatus 10 includes a plurality of measuring tools 104, and a controlling unit 100 for controlling the measuring tools 104 to perform specific measuring operations. The measuring tools 104 are a plurality of probes for measuring surface characteristics of a pick-up head carrier 12. Measuring result is transmitted over a data line 102 from the measuring tools 104 to the controlling unit 100. The controlling unit 100 is, for example, an oscilloscope, and depicts the measuring result on a screen 1000.

Each probe is assigned a transmitting channel for transmitting measuring result to the controlling unit 100. When the plurality of probes 104 are controlled to perform measuring operations at the same time, the measuring result generated by each probe 104 is transmitted respectively through the corresponding channel assigned to the probe 104 to the controlling unit 100. However, the controlling unit 100 has limited capability of depicting the measuring result transmitted through all channels.

In order to solve above-mentioned questions, either an alternate mode or a chop mode is employed. In the alternate mode, the controlling unit 100 depicts the measuring result transmitted through each channel alternatively. In the chop mode, the controlling unit 100 depicts the measuring result transmitted by all channels in a small time segments. Both the alternate modes and the chop modes are not capable of simultaneously depicting the measuring result transmitted through all channels.

Therefore, a measuring system which has the capability of simultaneously depicting the measuring result transmitted through all channels is desired.

### SUMMARY OF INVENTION

A multi-point measuring system includes a communicating module, a capturing module, and an interface module. The communicating module is used for enabling the multi-point measuring system to communicate with a measuring apparatus. The capturing module is used for generating and sending capturing commands to the measuring apparatus to obtain measuring result. The interface module is provided for providing a user interface for showing the measuring result.

A multi-point measuring method includes steps of: receiving an input command to start a measuring procedure; transmitting capturing commands to a measuring apparatus; receiving measuring values from the measuring apparatus; and depicting the measuring values through a user interface.

A multi-point measuring method includes steps of: sending controlling commands to at least two measuring tools to control the at least two measuring tools to measuring two different points of a component; receiving at least two measuring values from the at least two measuring tools; and showing the at least two measuring values on an user interface.

Other advantages and novel features will become more apparent from the following detailed description of preferred embodiments when taken in conjunction with the accompanying drawings, in which:

### BRIEF DESCRIPTION OF DRAWINGS

FIG. 1 is a block diagram of a multi-point measuring system in accordance with a preferred embodiment, the multi-point measuring system including a first controlling unit;

FIG. 2 is a detailed block diagram of the first controlling unit of FIG. 1;

FIG. 3 is an exemplary user interface;

FIG. 4 is a flow chart illustrating a working procedure of the multi-point measuring system of FIG. 1; and

FIG. 5 is schematic diagram of a conventional measuring apparatus.

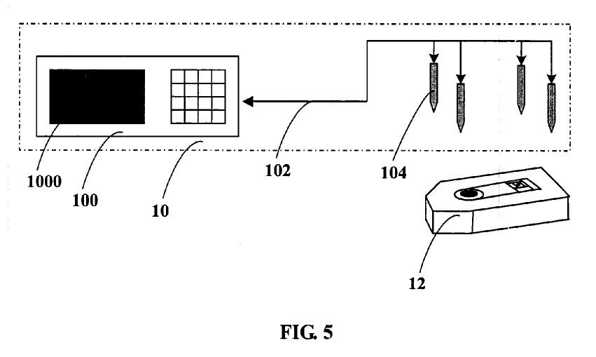

### DETAILED DESCRIPTION

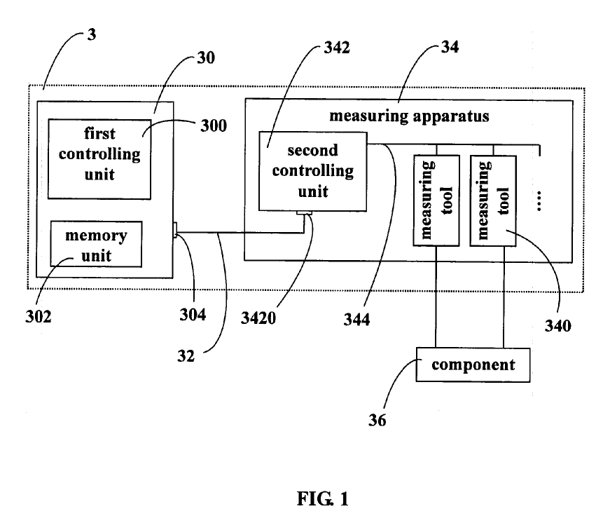

Referring to FIG. 1, a block diagram of a measuring system 3 in accordance with a preferred embodiment is illustrated. The measuring system 3 is used for measuring a component 36, and includes a controlling system 30, a measuring apparatus 34, and a first data line 32 interconnecting the controlling system 30 and the measuring apparatus 34. The component 36 can be a pick-up unit of an information recording and/or reproducing apparatus.

The controlling system 30 includes a first controlling unit 300, a memory unit 302, and a first input and output port 304. The first controlling unit 300 is provided for receiving measuring result from the measuring apparatus 34 and depicting the measuring result in a predetermined form. The memory unit 302 is used for storing the measuring result received from the first input and output port 304. The first input and output port 304 serves as a communicating interface between the controlling system 30 and the measuring apparatus 34. The first input and output port 304 can be serial or parallel.

The measuring apparatus 34 includes at least two measuring tools 340, a second controlling unit 342 for controlling the measuring tools 340 to perform specific measuring operations, and a second data line 344 interconnecting the measuring tools 340 and the second controlling unit 342. The measuring tools 340 can be probes, rulers, or other metrological instruments. The at least two measuring tools 340 are arranged for simultaneously measuring at least two different points of the component 36. The second controlling unit 342 includes a second input and output port 3420 corresponding to the first input and output port 304. Accordingly, the second input and output port 3420 can be serial or parallel.

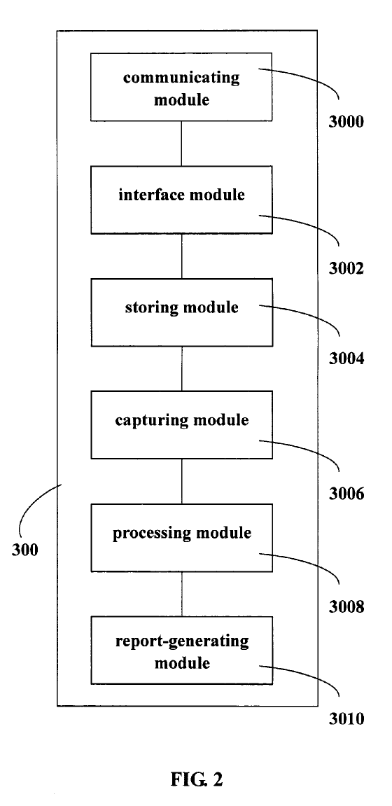

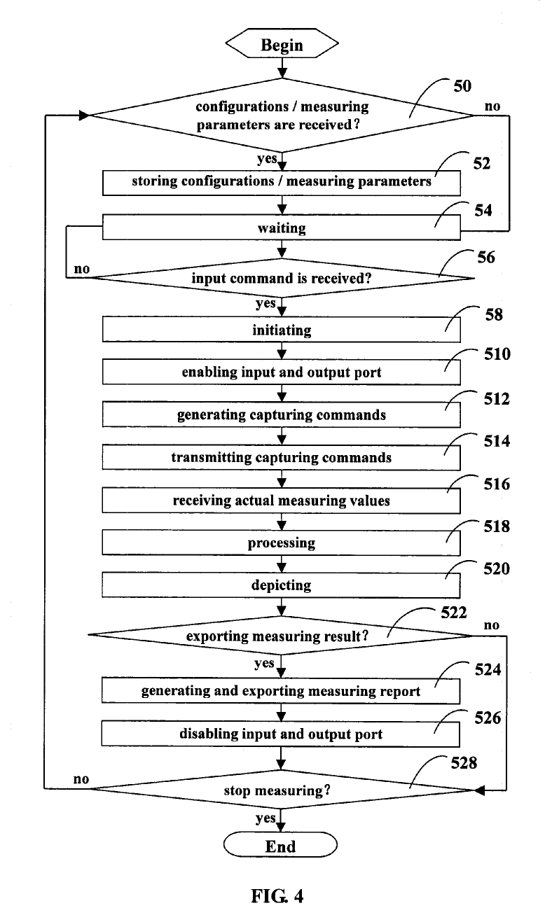

Referring to FIG. 2, a detailed block diagram of the first controlling unit 300 is illustrated. The first controlling unit 300 includes a communicating module 3000, an interface module 3002, a storing module 3004, a capturing module 3006, a processing module 3008, and a report-generating module 3010. The communicating module 3000 is used for enabling the first input and output port 304 to communicate with the second input and output port 3420. The interface module 3002 is utilized for creating a user interface (shown in FIG. 4), through which input commands are entered and the measuring result is displayed. The storing module 3004 is provided for storing measuring parameters. The capturing module 3006 is used for receiving the input commands and generating capturing commands based on the measuring parameters. The capturing commands are capable of being recognized by the second controlling unit 342 of the measuring apparatus 34. The processing module 3008 is used for receiving the measuring result from the second controlling unit 342 and processing the measuring result so that the measuring result can be depicted and shown through the user interface. The report-generating module 3010 is used for generating a measuring report based on the measuring result.

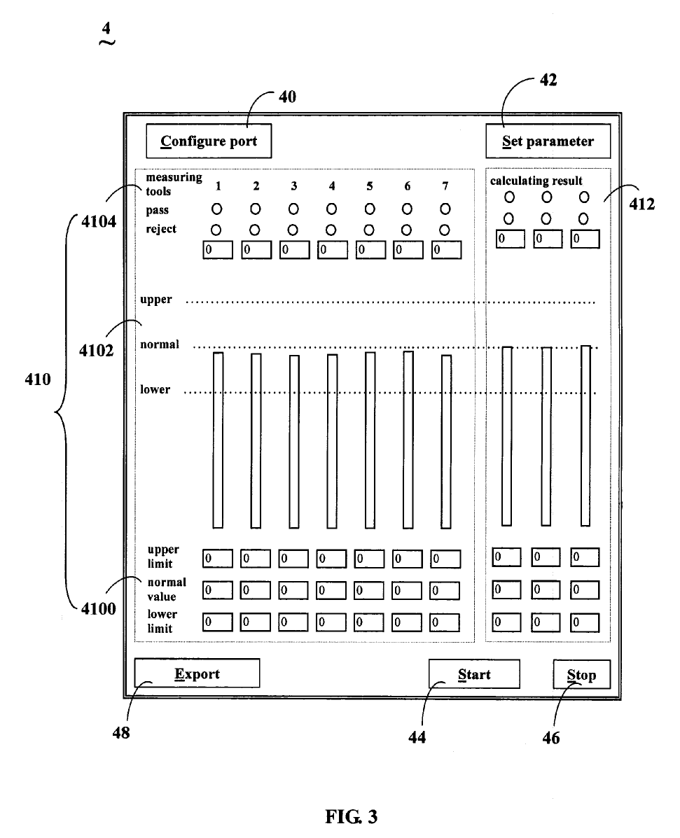

Referring to FIG. 3, an exemplary user interface 4 created by the interface module 3002 is illustrated. The user interface 4 includes a “Configure port” button 40, a “Set parameter” button 42, a “Start” button 44, a “Stop” button 46, an “Export” button 48, and a first display form 410 and a second display form 412. The “Configure port” button 40 is provided for configuring the first input and output port 304. After the “Configure port” button is clicked, configuration parameters, including port types and transmitting rates, can be entered. The “Set parameter” button 42 is provided for setting measuring parameters. After the “Set parameter” button 42 is clicked, measuring parameters, including the number of measuring tools that are required to work simultaneously, a location of each measuring tool, and moving directions of each measuring tool, can be entered. The “Start” button 44 is provided for starting a measuring procedure. That is, upon the “Start” button 44 is clicked, the measuring procedure begins. The “Stop” button 46 is used for stopping the measuring procedure. That is, upon the “Stop” button 46 is clicked, the measuring procedure is stopped. The “Export” button 48 is used for exporting the measuring reports. The first display form 410 is used for showing actual values measured by each measuring tool 340 and comparison between actual values and predetermined values. The predetermined values include normal values, upper limits, and lower limits. The first display form 410 is divided into three portions 4100, 4102 and 4104. A first portion 4100 is used for showing the predetermined values. A second portion 4102 is a histogram illustrating the actual values got from the measuring tools 340. A third portion 4104 is used for showing the actual values. The second display form 412 is used for showing calculating result of the actual values. The calculating result is computed based on predetermined statistical functions, such as a weighted average of the actual values, or an average of differences among the actual values.

Referring to FIG. 4, a flow chart illustrating a working procedure of the multi-point measuring system 3 in accordance with a preferred embodiment is illustrated. The measuring procedure begins at step 50, where a determination is made as to whether configurations of the first input and output port 304 and/or the measuring parameters are received. If configurations of the first input and output port 304 and/or the measuring parameters are received, the configurations of the first input and output port 304 and/or the measuring parameters are received then are stored in the memory unit 302 (step 52). Then, in step 54, the capturing module 3006 waits for an input command. In step 56, a determination is made as to whether an input command, such as a click on the “Start” button 44, is received. If such input command is not received, the measuring procedure returns to step 54. If such input command is received, the measuring procedure proceeds to step 58, where the multi-point measuring system 3 performs initiating operations, such as locating each measuring tool 340 at a predetermined position according to the measuring parameters, zero filling the measuring result etc. Then, in step 510, the communicating module 3000 compares the configurations of the first input and output port 304 stored in the memory unit 302 with those of the second input and output port 3420 to determine whether the configurations of the first input and output port 304 match with those of the second input and output port 3420. If the configurations of the first input and output port 304 match with those of the second input and output port 3420, the communicating module 3000 enables the first input and output port 304 so that the first input and output port 304 can communicate with the second input and output port 3420. The capturing module 3006 generates capturing commands (step 512). The capturing commands are capable of being recognized by the second controlling unit 342. The capturing commands are then transmitted to the second controlling unit 342 through the first input and output port 304 (step 514). Upon receiving the capturing commands, the second controlling unit 342 feeds back actual measuring values come from the measuring tools 340. The processing module 3008 receives the actual measuring values (step 516) and processes the actual measuring values (step 518). The processing operations include transforming the actual measuring values into a predetermined format, computing calculating result based on predetermined statistical functions, and comparing the actual measuring values or the calculating result with the predetermined values to determine whether the component 36 is qualified. Then, in step 520, processing result from the processing module 3008 is depicted and shown through the user interface 4. Therefore, measuring result got from all the measuring tools 340 are shown simultaneously. Then, the measuring procedure proceeds to step 522, where a determination is made as to whether it is needed to export the measuring result. If it is needed to export the measuring result, the measuring procedure proceeds to step 524, the report-generating module 3010 generates a measuring report and then exports the measuring report. Then, in step 526, the communicating module 3000 disabled the first input and output port 304. Finally, the measuring procedure proceeds to step 528, where a determination is made as to where it is needed to stop the measuring procedure. If it is needed to stop the measuring procedure, the measuring procedure is ended. If it is not needed to stop the measuring procedure, the measuring procedure returns to step 50.

The embodiments described herein are merely illustrative of the principles of the present invention. Other arrangements and advantages may be devised by those skilled in the art without departing from the spirit and scope of the present invention. Accordingly, the present invention should be deemed not to be limited to the above detailed description, but rather by the spirit and scope of the claims that follow, and their equivalents.

What is claimed is:

1. A multi-point measuring system, comprising:
a communicating module for enabling the multi-point measuring system to communicate with a measuring apparatus;
a capturing module for generating and sending capturing commands to the measuring apparatus to obtain measuring result; and
an interface module for providing a user interface for showing the measuring result.

2. The multi-point measuring system as claimed in claim 1, wherein the measuring apparatus comprises at least two measuring tools for simultaneously measuring at least two different points of a component, and the measuring result comprises measuring values measured by said at least two measuring tools.

3. The multi-point measuring system as claimed in claim 2, wherein the measuring values synchronously got from said at least two measuring tools are shown simultaneously through the user interface.

4. The multi-point measuring system as claimed in claim 1, further comprising a processing module for receiving the measuring result and processing the measuring result so that the measuring result can be shown through the interface module.

5. The multi-point measuring system as claimed in claim 4, wherein the processing operations comprise transforming the measuring values into a predetermined format, and comparing the measuring values with predetermined values to determine whether the measuring values is within an appropriate range.

6. The multi-point measuring system as claimed in claim 1, further comprising an input and output port connecting with the measuring apparatus via a data line.

7. The multi-point measuring system as claimed in claim 1, further comprising a memory unit for storing measuring parameters, the measuring parameters including the number of measuring tools and locations of the measuring tools.

8. The multi-point measuring system as claimed in claim 6, wherein the capturing commands are generated based on the measuring parameters.

9. A multi-point measuring method comprising:
receiving an input command to start a measuring procedure;
transmitting capturing commands to a measuring apparatus;
receiving measuring values from the measuring apparatus; and
depicting the measuring values through a user interface.

10. The multi-point measuring method as claimed in claim 9, wherein the measuring apparatus includes at least two measuring tools for simultaneously measuring at least two different points of a component, and the measuring values are obtained from said at least two measuring tools.

11. The multi-point measuring method as claimed in claim 10, wherein the measuring values synchronously got from said at least two measuring tools are shown simultaneously through the user interface.

12. The multi-point measuring method as claimed in claim 9, further comprising:
storing measuring parameters to a memory unit, the parameters including the number of measuring tools and locations of the measuring tools; and
generating capturing commands based on the measuring parameters.

13. The multi-point measuring method as claimed in claim 12, further comprising a step of receiving the measuring parameters through the user interface.

14. The multi-point measuring method as claimed in claim 9, further comprising a step of processing the measuring values so that the measuring values can be shown in a predetermined format.

15. The multi-point measuring method as claimed in claim 9, wherein the step of processing the measuring values further comprising transforming the measuring values into a predetermined format, and comparing the measuring values with predetermined values to determine whether the measuring values is within an appropriate range.

16. The multi-point measuring method as claimed in claim 9, further comprising a step of enabling an input and output port to communicate with the measuring apparatus when the input command is received.

17. A multi-point measuring method, comprising:
sending controlling commands to at least two measuring tools to control said at least two measuring tools to measure two different points of a component;
receiving at least two measuring values from said at least two measuring tools; and
showing said at least two measuring values on an user interface.

18. The multi-point measuring method as claimed in claim 17, further comprising:
comparing the measuring values with predetermined values to determine whether the measuring values are within an appropriate scope.

19. The multi-point measuring method as claimed in claim 18, further comprising:
showing comparisons between the measuring values and the predetermined values on the user interface.

20. The multi-point measuring method as claimed in claim 17, further comprising:
generating a measuring report based on the measuring values.
